(19) United States
(12) Patent Application Publication
(10) Pub. No.: US 2008/0047149 A1
(43) Pub. Date: Feb. 28, 2008

(54) Hand-Holdable Utensils for Food Preparation

(76) Inventor: Nicholas J. Webb, Redding, CA (US)

Correspondence Address: GORDON & JACOBSON, P.C., 60 LONG RIDGE ROAD, SUITE 407, STAMFORD, CT, 06902, US

(21) Appl. No.: 11/467,657

(22) Filed: Aug. 28, 2006

(51) Int. Cl. A01D 1/00

(52) U.S. Cl. 30/278

(57) ABSTRACT

A utensil for food preparation includes a handle for grasping by a human hand, and a member projecting forward from the handle. The member has a sharpened edge and at least one curved edge spaced from the sharpened edge. In one embodiment, the curved edge is sized and shaped to generally conform to the profile of a fruit pit. At least one pitting spike extends from the curved edge for engaging the fruit pit. The sharpened edge provides a cutting surface which is intended to cut the fruit in half. The cutting surface can also be used to cut and dice the fruit while in its skin. In another embodiment, the member is generally spoon-shaped and includes a basin disposed adjacent the sharpened edge. The basin has a central opening with a plurality of projections spaced apart and extending generally inward toward one another. Preferably, the projections are adapted to engage the skin of a clove of garlic placed therebetween in order to peel the skin from the clove. The sharpened edge can be used to cut and dice the peeled clove into chunks or smaller pieces if desired.

### BACKGROUND OF THE INVENTION

1. Field of the Invention

This invention relates to hand-holdable utensils for food preparations.

2. State of the Art

The process of preparing avocados and other soft fruits for consumption is comprised of four primary steps including: cutting the fruit in half removing the pit, slicing and dicing, and removing the fruit from the skin.

A sharp knife can be used to perform these tasks. However, the sharp tip of the knife is prone to piercing through the skin of the avocado, which can cause serious injury.

Dedicated tools for preparing avocados have been developed and sold commercially. An example is the tool available from Amco Houseworks, a division of Focus Products Group, LLC (see http://www.focuspg.com), which includes a lasso-like blade that carves the pit from the fruit with a secondary instrument (wire-slicer) that provides longitudinal slices while removing the fruit from the skin. This device is bulky. It also requires a separate instrument (such as a steak knife) in order to cut the fruit in half, which significantly increases the time and labor necessary to prepare the fruit for consumption. Additionally, pits can have a wide variety of shapes and sizes. The lasso-like blade of does not accommodate pits of different sizes and shapes, and thus results in wasted fruit.

Therefore, a need exists in the art for a tool for preparing an avocado (or other fruit with a pit) that is effective and efficient, accommodates pits of different sizes and shapes and thus minimizes wasted fruit, and reduces the risk of injuries in preparing the fruit.

In another aspect, a garlic clove is typically peeled by mashing the clove with the blade of a knife and using the sharp point of the knife to separate the skin from the clove. However, this process is inefficient as it takes time to separate the skin from the clove. It is also unsafe as the sharp tip of the knife is prone to piercing through the skin of the garlic clove, which can cause serious injury.

Therefore, a need exists in the art for a tool for peeling a garlic clove that is effective and efficient and that reduces the risk of injuries in preparing the garlic for consumption.

### SUMMARY OF THE INVENTION

It is therefore an object of the invention to provide a tool for preparing an avocado or other fruit with a pit that is effective and efficient in preparing the fruit for consumption.

It is another object of the invention to provide such a tool that accommodates pits of different sizes and shapes and thus minimizes wasted fruit.

It is a further object of the invention to provide such a tool that reduces the risk of injuries in preparing the fruit.

It is yet another object to provide a tool for preparing garlic that is effective and efficient and that reduces the risk of injuries in preparing the garlic for consumption.

In accord with these objects, which will be discussed in detail below, a utensil for food preparation includes a handle for grasping by a human hand, and a member projecting forward from the handle. The member has a sharpened edge and at least one curved edge spaced from the sharpened edge.

In one embodiment, the curved edge is sized and shaped to generally conform to the profile of a fruit pit (e.g., avocado pit, peach pit, plum pit, mango pit). At least one pitting spike extends from the curved edge for engaging the fruit pit. The sharpened edge provides a cutting surface which is intended to cut the fruit in half. The pitting spike(s) engage the fruit pit in order to apply torsional forces that separate the pit from the fruit and to remove the pit. The cutting surface can also be used to cut and dice the fruit while in its skin. The utensil can also have a sharp rounded distal tip that is used to remove the fruit from the skin with minimal risk of piercing the skin of the fruit. Advantageously, the utensil is effective and efficient in preparing the fruit for consumption. The pitting spike(s) also accommodates pits of different sizes and shapes and thus minimizes wasted fruit. The utensil also reduces the risk of injuries in preparing the fruit.

In another embodiment, the member is generally spoon-shaped and includes a basin disposed adjacent the sharpened edge. The basin has a central opening with a plurality of projections spaced apart and extending generally inward toward one another. Preferably, the projections are adapted to engage the skin of a clove of garlic placed therebetween in order to peel the skin from the clove. The sharpened edge can be used to cut and dice the peeled clove into chunks or smaller pieces if desired. The utensil can also have a blunt distal tip that is intended to be used to separate a discrete clove from a garlic bulb without damaging adjacent cloves. Advantageously, the utensil is effective and efficient in preparing garlic and also reduces the risk of injuries in preparing the garlic for consumption.

Additional objects and advantages of the invention will become apparent to those skilled in the art upon reference to the detailed description taken in conjunction with the provided figures.

### BRIEF DESCRIPTION OF THE DRAWINGS

FIG. 1A is a side view of a hand-holdable utensil for food preparation in accordance with the present invention;

FIG. 1B is a top view of the hand-holdable utensil of FIG. 1A;

FIGS. 2A and 2B are diagrams illustrating exemplary dimensions of the hand-holdable utensil of FIGS. 1A and 1B;

FIGS. 3A-3E are views of another hand-holdable utensil for food preparation in accordance with the present invention; FIG. 3A is a partial rear-perspective view of the hand-holdable utensil; FIG. 3B is a partial plan view of the hand-holdable utensil; FIG. 3C is a partial front-perspective view of the hand-holdable utensil; FIG. 3D is a partial left-side view of the hand-holdable utensil; FIG. 3E is a partial right-side view of the hand-holdable utensil; and

FIGS. 4A and 4B are diagrams illustrating exemplary dimensions of the hand-holdable utensil of FIGS. 3A-3E.

### DETAILED DESCRIPTION OF THE PREFERRED EMBODIMENTS

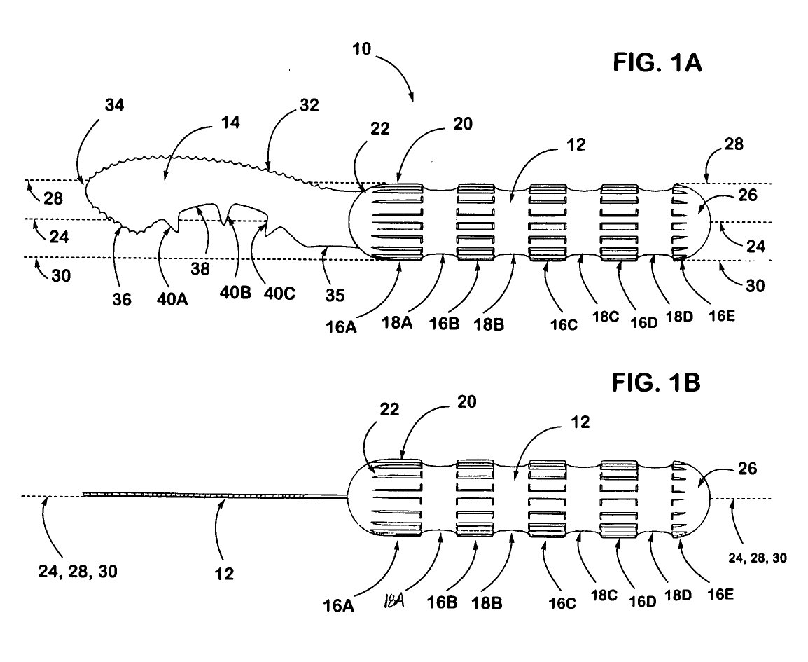

Turning now to FIGS. 1A and 1B, a hand-holdable utensil for food preparation in accordance with the present invention is indicated generally by the numeral 10. The utensil 10 includes a handle portion 12 and an elongate generally-planar blade portion 14. The handle portion 12 is grasped by the hand of the person using the utensil. The handle portion 12 includes a plurality of annular-shaped raised sections along its length (e.g., five shown as 16A, 16B, 16C, 16D, 16E) with annular recesses (e.g., 4 shown as 18A, 18B, 18C, 18D) therebetween.

Each raised section (16A, 16B, 16C, 16D, 16E) defines a set of alternating ridges 20 and grooves 22 that extend parallel to the longitudinal axis 24 of the handle. The ridges 20 and grooves 22 are evenly spaced about the circumference of the given annular-shaped raised section. The ridges 20 and grooves 22 of the raised sections together with the annular recesses between raised sections provide for increased traction, especially in wet food preparation environments. The raised section (16A) nearest the blade is preferably larger in length than the raised sections between it and the handle end 26, while the raised section (16E) nearest the handle end 26 is preferably smaller in length than the raised sections between it and the blade portion 14 as shown. The handle end 26 is preferably realized as a blunt rounded surface as shown.

The periphery of the handle portion 12 defines top and bottom axes 28, 30 that extend parallel to the longitudinal axis 24 in a co-planar relationship relative to the plane of the blade as shown in FIG. 1A. The handle portion 12 is preferably realized from an FDA-approved food contact plastic (such as acrylic and modified acrylic plastics, polymers of acrylonitrile and styrene, ethylene-based polymers, isobutylene-based polymers, polycarbonate-based polymers, polyethylene-based polymers, polystyrene-based polymers, polyurethane-based polymers). The plastic material of the handle portion 12 preferably has an aggressive electrical-discharge-milled (EDM) finish for improved traction, especially in wet food preparation environments. The handle portion 12 can also be realized from a ceramic or glass material.

As best shown in FIG. 1A, the blade portion 14 includes a curved top edge 32 that extends from the handle portion 12 to a tip portion 34. Preferably, the curved top edge 32 extends upward in a convex manner beyond the forward projection of the top axis 28 of the handle portion as shown. The curved top edge 32 is sharpened, preferably with a serrated configuration, to provide a cutting surface suitable for breaking the skin of avocados and other fruits with pits (e.g., peach, plum, mango, etc.). The tip portion 34 is sharpened but rounded in order to minimize the risk of cutting through the skin of the avocado or other fruit while slicing and dicing the fruit therein, and thus prevents injuries that might otherwise result. Preferably, the distal tip portion 34 has a radius in the range between 5 mm and 10 mm.

The blade 14 also includes a bottom edge 35 extends from the distal tip portion 34 back to the handle portion 12. The bottom edge 35 includes a first curved section 36 that is disposed adjacent the distal tip portion 34. The first curved section 36 extends downward in a convex manner and is preferably sharpened (most preferably in a serrated configuration) to provide a cutting surface suitable for breaking the skin of avocados and other fruits with pits. The bottom edge 35 also includes a second curved section 38 that is disposed rearward of the first curved section 36 and that extends upward in a concave manner. One or more pitting spikes (for example, three shown as 40A, 40B, 40C) project from the second curved section 38. The second curved section 38 is sized and shaped to generally follow the typical contour of an avocado pit or other fruit pit. The pitting spike(s) (40A, 40B, 40C) are adapted to dig into and engage the exterior surface of the pit. The pitting spikes can have conforming shapes and sizes, or different shapes and sizes. In the illustrative embodiment shown of FIGS. 1A and 1B, the second curved section 38 defines an open “C” radius with three pitting spikes 40A, 40B, 40C projecting radially therefrom. Preferably, the second curved section 38 has a radius between 25 mm and 45 mm. The three pitting spikes 40A, 40B, 40C have similar triangular profiles, with the middle pitting spike 40B being slightly larger in height relative to the other two 40A, 40C. This configuration allows the pitting spikes to better accommodate a wide range of pit sizes. It is contemplated that other shapes, sizes and configurations can be used for the pitting spikes. When more than one pitting spike is used, the pitting spikes are spaced-apart from one another along the second curved section. In the illustrative embodiment of FIGS. 1A and 1B, the three pitting spikes are substantially evenly spaced-apart from one another along the second curved surface. Preferably, the bottom edge 35 of the blade 14 (including the first curved section 36 and the second curved section 38) does not extend downward beyond the forward projection of the bottom axis 30 defined by the handle portion 12 as shown.

The blade portion 14 is preferably realized from a metal that is resistant to rusting and wear (i.e., maintains a sharp cutting edge over a long period of use), such as stainless steel. Alternatively, the blade portion 14 can possibly realized from a ceramic material.

The handle portion 12 can be connected to the blade portion 14 by overmolding, ultrasonic welding, or by an adhesive.

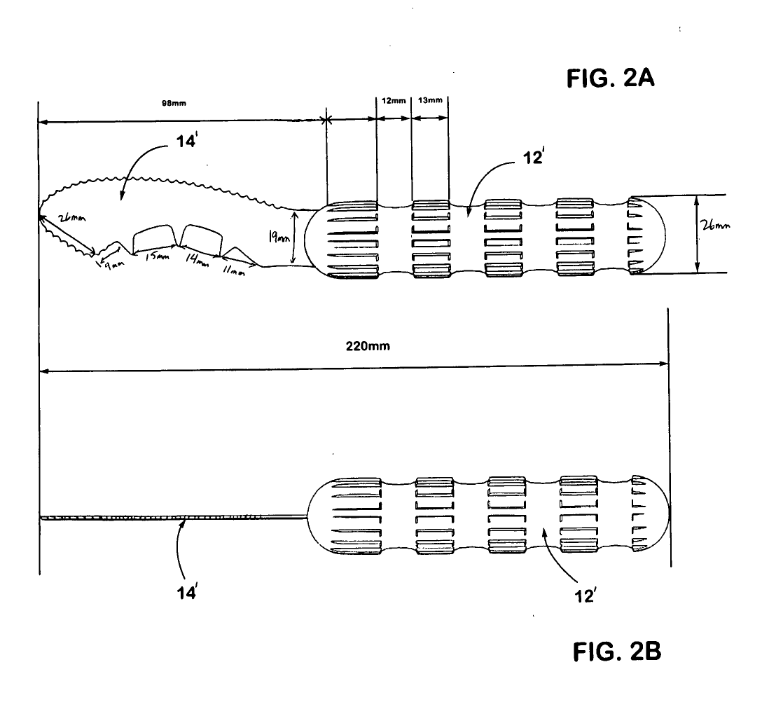

Exemplary dimensions of the utensil of FIGS. 1A and 1B are shown in FIGS. 2A and 2B.

The utensil of FIGS. 1A and 1B is intended to be used to remove the pit of an avocado or other fruit (e.g., peach, plum, mango, etc.) by first using the cutting edge 32 or cutting edge 36 to create a slice encircling the fruit down through the skin to the pit. The fruit, with the skin remaining, can then be split into halves with the pit remaining in one half of the fruit. The pit is removed from this half by placing the curved section 38 over the pit and firmly presses down such that the pitting spike(s) dig into and engage the exterior surface of the pit. The user then rotates the utensil (and pit engaged therewith) relative to the fruit in order to apply a torsional force on the pit, which causes the pit to separate from the fruit. The user can then pull the pit from the pitting spike(s), if need be. The user can use the cutting edge of the curved section 36 and/or the top cutting edge 32 to slice and dice the fruit of the two halves within their respective skins. The distal tip portion 34 of the utensil can be used to scoop out the diced fruit as needed. The tip portion 34 is rounded in order to minimize the risk of cutting through the skin of the fruit while slicing and dicing the fruit, and thus prevents injuries that might otherwise result.

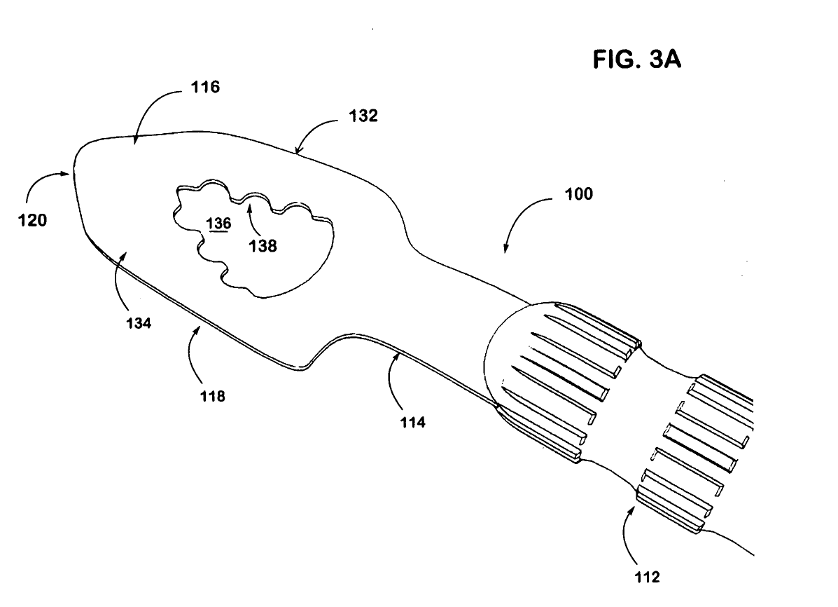

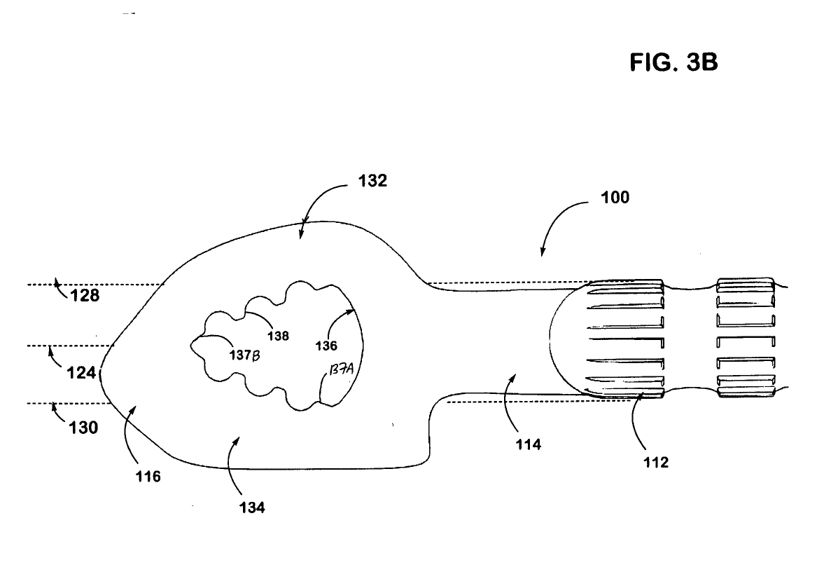

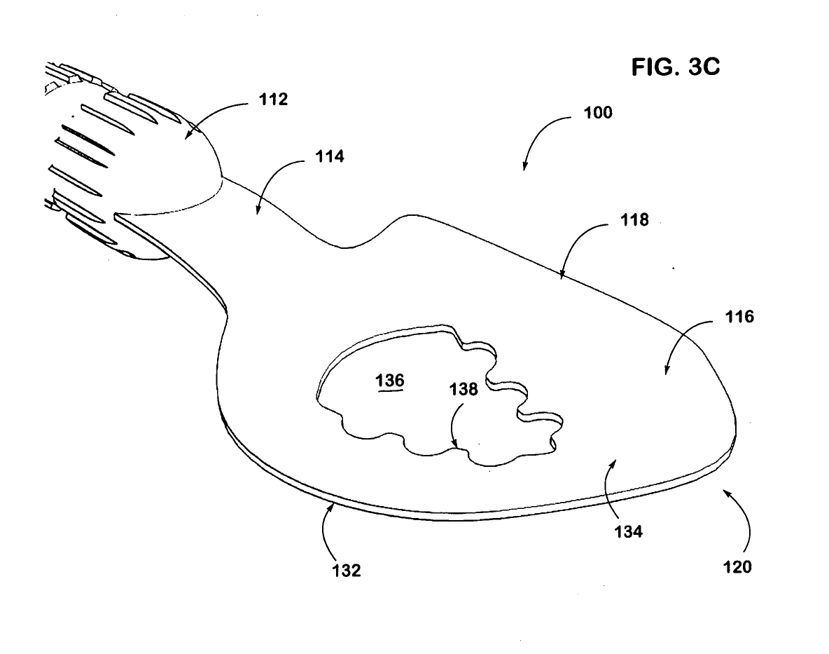

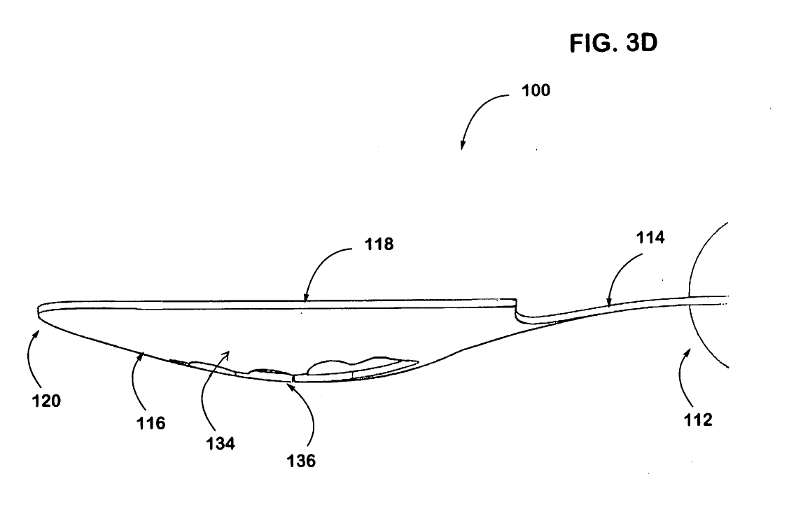

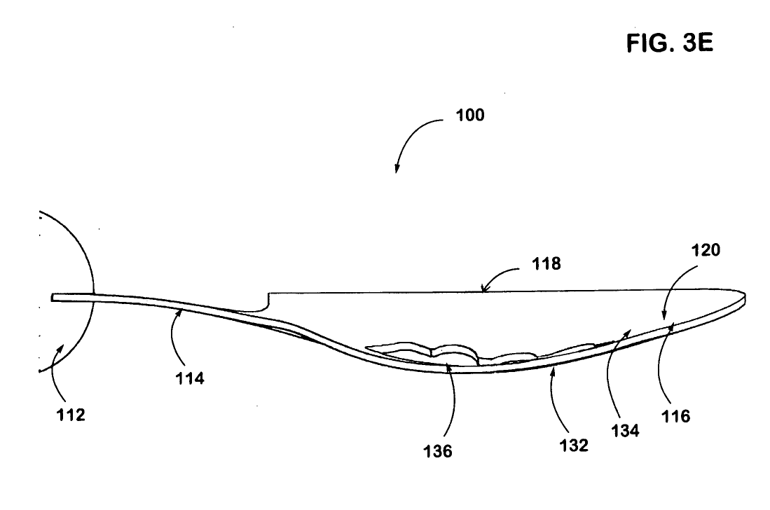

Another hand-holdable utensil for food preparation in accordance with the present invention is indicated generally by the numeral 100 in FIGS. 3A-3E. The utensil 100 is intended to be used to separate a clove of garlic from a garlic bulb (which is sometimes referred to as a “garlic head”), to remove the skin from the individual clove, and then to cut and dice the skinned clove into chunks or smaller pieces if desired. The utensil 100 includes a handle portion 112 with a substantially-planar neck portion 114 extending to a spoon-shaped portion 116. The handle portion 112 is grasped by the hand of the person using the utensil. The handle portion 112 is similar to the handle portion 12 of the utensil of FIGS. 1A and 1B as described above and thus is omitted here for simplicity of description. In this configuration, the handle portion 112 has a longitudinal axis 12, and the periphery of the handle portion 112 defines first and second axes 128, 130 that extend parallel to the longitudinal axis 124 in a co-planar relationship relative to the plane of the neck portion 114 as best shown in FIG. 3B.

The spoon-shaped portion 116 includes a sharpened edge 118 that extends parallel to the longitudinal axis 124 of the handle portion 112. The sharpened edge 118 is used to cut and dice a garlic clove once its skin has been removed. The orientation of the sharpened edge 118 parallel to the longitudinal axis of the handle portion 112 provides for easy and stable chopping and dicing of the garlic clove.

The spoon-shaped portion 116 also includes a blunt tip 120 for separating a discrete clove from the bulb. The blunt tip 120 can be positioned gently between garlic cloves in a bulb and provides an easy and convenient way to remove a clove without damaging adjacent cloves as is commonplace when using a sharp knife.

The spoon-shaped portion 116 has a blunt curved edge 132 disposed opposite the sharpened edge 118. A basin 134 is disposed between the sharpened edge 118 and the curved edge 132. The curved edge 132 is disposed below the sharpened edge 118 and the basin 134 is contoured such that it is shallow adjacent the curved edge 132 and deeper adjacent the sharpened edge 118. The central portion of the basin 134 has an opening 136 therethrough. The central opening 136 has projections 138 spaced apart along its edges that extend generally inward toward one another. The profile of the tips of the projections 138 generally conforms to the size and shape of a garlic clove. The projections 138 are used to grasp the skin of a garlic clove placed therebetween. Preferably, the projections 138 have a tooth-shaped profile with a blunt tip as shown, which is used for engaging the skin of a garlic clove. Note that other shapes, sizes and configurations of the projections 138 can be used. Preferably, the projections 138 can be used to peel away the skin of the garlic clove, most preferably by placing a garlic clove under the opening 136 and then pushing the basin 134 downward by hand manipulation of the handle portion 112. The opening 136 preferably has a shape with opposing ends with one end being narrower than the other end. For example, in the illustrative embodiment shown, the opening 136 has a generally conical profile with a wide end 137A opposite a narrow end 137B as best shown in FIG. 3B. In this configuration, the projections 138 have a tapered design that accommodates a variety of shapes and sizes of cloves. Note that other shapes, sizes and configurations of the central opening 136 can be used.

The neck portion 114 and the spoon-shaped portion 116 are preferably realized as a unitary member constructed from a metal that is resistant to rusting and wear (i.e., maintains a sharp cutting edge over a long period of use), such as stainless steel. Alternatively, the neck portion 114 and the spoon-shaped portion 116 can possibly realized from a ceramic material.

The handle portion 112 can be connected to the neck portion 114 by overmolding, ultrasonic welding, or by an adhesive.

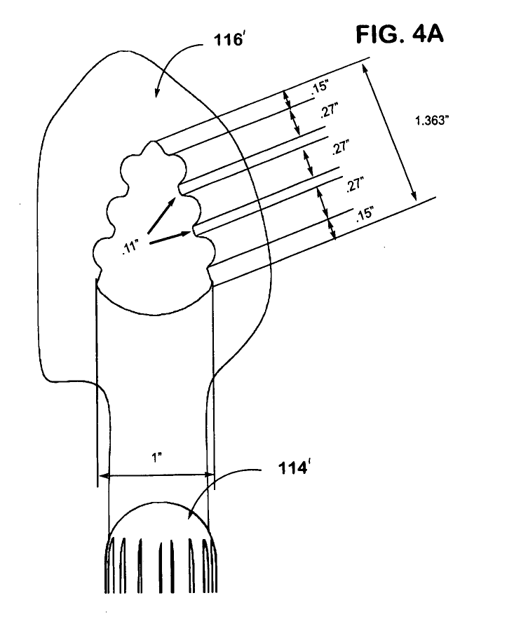

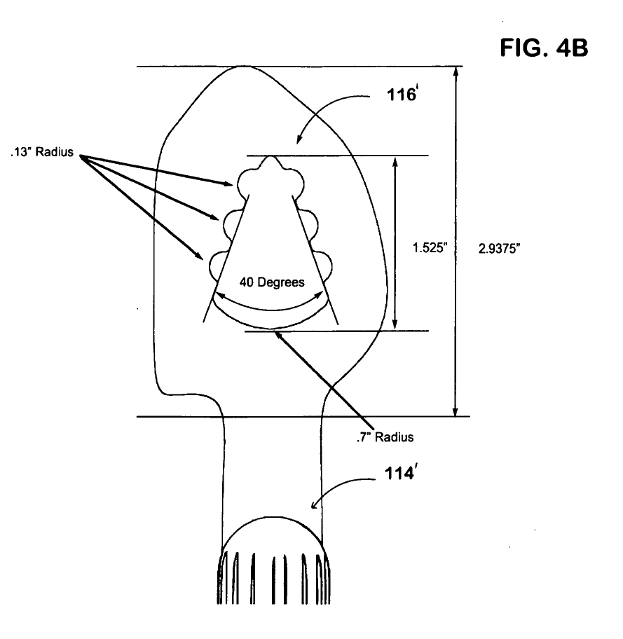

Exemplary dimensions of the utensil of FIGS. 3A-3E are shown in FIGS. 4A and 4B.

The utensil of FIGS. 3A-3E is intended to be used to separate a clove of garlic from a garlic bulb, to remove the skin from the individual clove, and then to cut and dice the skinned clove into chunks or smaller pieces if desired. First, the user uses the blunt tip 120 to pry at the garlic bulb and separate a discrete clove from the bulb. The clove is then placed on a flat surface (e.g., countertop) under and adjacent to the central opening 136 of the utensil 100. In this position, the handle portion 112 is positioned at an angle relative to the flat surface. The user then moves the basin 134 downward by hand manipulation of the handle portion 112. The downward action causes the projections 138 to engage the skin of the glove and peel it away. When the handle portion 112 contacts (or nearly contacts) the flat surface, the peeling action is complete. The user can then use the cutting edge 118 to slice and dice the glove into chunks or smaller pieces if desired.

There have been described and illustrated herein several embodiments of utensils for food preparation and methods of using same. While particular embodiments of the invention have been described, it is not intended that the invention be limited thereto, as it is intended that the invention be as broad in scope as the art will allow and that the specification be read likewise. Thus, while particular handle designs have been disclosed, it will be appreciated that other handle designs can be used as well. In addition, while particular shapes, sizes and dimensions of various features have been disclosed, it will be understood that other feature shapes, sizes and dimensions can be used. For example, it is possible to other shapes, sizes and dimensions for the neck portion of the utensil of FIGS. 3A-3E. Moreover, while particular uses have been discussed for the utensils disclosed herein, it will be appreciated that the utensils can be used for other purposes not specifically disclosed herein. It will therefore be appreciated by those skilled in the art that yet other modifications could be made to the provided invention without deviating from its spirit and scope as claimed.

What is claimed is:

1. A utensil for food preparation comprising:
a handle for grasping by a human hand; and
a member projecting forward from the handle, the member having a sharpened edge and at least one curved edge spaced from the sharpened edge, wherein the member includes at least one of the following:
i) the curved edge being sized and shape to generally conform to the profile of a fruit pit, and at least one pitting spike that extends from the curved edge for engaging the fruit pit; and
ii) the member having a general spoon shape with a basin disposed adjacent the sharpened edge, the basin having a central opening with a plurality of projections spaced apart and extending generally inward toward one another.

2. A utensil according to claim 1, wherein:
the at least one pitting spike extends from the curved edge in a direction away from the sharpened edge.

3. A utensil according to claim 2, wherein:
the fruit pit is selected from the group including: an avocado pit, a peach pit, a plum pit, and a mango pit.

4. A utensil according to claim 2, wherein:
the member is an elongate substantially-planar blade having a top edge and a bottom edge, the sharpened edge being disposed along a convexly-curved portion of the top edge, and the pitting spikes extending from a concavely-curved portion of the bottom edge.

5. A utensil according to claim 4, wherein:
the handle has a longitudinal axis and periphery of the handle defines top and bottom axes that are parallel to the longitudinal axis, wherein the convexly-curved portion of the top edge of the blade extends upward beyond the forward projection of the top axis, and wherein the pitting spikes and the concavely-curved portion of a bottom edge do not extend downward beyond the forward projection of the bottom axis.

6. A utensil according to claim 4, wherein:
the bottom edge of the blade includes a convexly-curved portion that is sharpened for cutting purposes.

7. A utensil according to claim 1, wherein:
the at least one pitting spikes have a triangular shape.

8. A utensil according to claim 1, wherein:
the at least one pitting spike comprise a plurality of pitting spikes spaced apart along the curved surface.

9. A utensil according to claim 1, wherein:
the curved surface is defined by an open C-shaped radius in the range between 25 mm and 45 mm.

10. A utensil according to claim 1, wherein:
the member has a sharp rounded distal tip.

11. A utensil according to claim 1, wherein:
the basin being disposed between the sharpened edge and a blunt curved edge, the blunt curved edge disposed below the sharpened edge, and the basin being contoured such that it is shallow adjacent the blunt curved edge and deeper adjacent the sharpened edge.

12. A utensil according to claim 11, wherein:
the central opening and space between opposing projections tapers along the length of the central opening.

13. A utensil according to claim 1, wherein:
the plurality of projections are adapted to grasp the skin of a garlic clove placed therebetween.

14. A utensil according to claim 13, wherein:
the projections have a blunt tip for engaging the skin of the garlic glove.

15. A utensil according to claim 1, wherein:
the member has a blunt tip.

16. A utensil according to claim 1, wherein:
the handle includes a plurality of annular-shaped raised sections along its length with annular recesses therebetween.

17. A utensil according to claim 16, wherein:
each raised section defines a set of alternating ridges and grooves that extend parallel to the longitudinal axis of the handle.

18. A utensil according to claim 17, wherein:
the ridges and grooves are evenly spaced about the circumference of the given annular-shaped raised section.

19. A utensil according to claim 15, wherein:
the handle is realized from a plastic material with an electrical-discharge-milled (EDM) finish for improved traction.

20. A utensil according to claim 1, wherein:
the member is realized from stainless steel.
